(19) United States
(12) Patent Application Publication
(10) Pub. No.: US 2026/0337047 A1
(43) Pub. Date: Oct. 29, 2026

(54) SYNTHESIS OF LITHIUM LANTHANUM ZIRCONATE FROM NANOCRYSTALLINE LANTHANUM ZIRCONATE

(71) Applicants: Jon Weller, Phoenix, AZ (US); Candace Chan, Phoenix, AZ (US)

(72) Inventors: Jon Weller, Phoenix, AZ (US); Candace Chan, Phoenix, AZ (US)

(21) Appl. No.: 19/178,509

(22) Filed: Apr. 14, 2025

Related U.S. Application Data
(62) Division of application No. 18/449,209, filed on Aug. 14, 2023, now Pat. No. 12,304,832.
Application No. 18/449,209 is a continuation of application No. 17/396,967, filed on Aug. 9, 2021, now Pat. No. 11,760,652.
Application No. 17/396,967 is a division of application No. 16/399,331, filed on Apr. 30, 2019, now Pat. No. 11,084,734.
(60) Provisional application No. 62/667,383, filed on May 4, 2018.

(51) Int. Cl. C01G 25/00; B82Y 40/00; C08K 5/053; C08K 5/09; C08L 29/14; C08L 33/08; C08L 33/10

(52) U.S. Cl. CPC C01G 25/006; C08K 5/053; C08K 5/09; C08L 29/14; C08L 33/08; C08L 33/10; B82Y 40/00; C01P 2002/52; C01P 2002/60; C01P 2002/72; C01P 2004/03; C01P 2004/04

(57) ABSTRACT

Fabricating a layer including lithium lanthanum zirconate layer includes forming a slurry including lanthanum zirconate nanocrystals, a lithium precursor, and a lanthanum precursor in stoichiometric amounts to yield a dispersion including lithium, lanthanum, and zirconium. The slurry is dispensed onto a substrate and dried. The dried slurry is calcined to yield the layer including lithium lanthanum zirconate.

### CROSS-REFERENCE TO RELATED APPLICATIONS

This application is a divisional of U.S. application Ser. No. 18/449,209 filed on Aug. 14, 2023, which is a continuation of U.S. application Ser. No. 17/396,967 filed on Aug. 9, 2021, now U.S. Pat. No. 11,760,652, which is a divisional of U.S. application Ser. No. 16/399,331 filed on Apr. 30, 2019, now U.S. Pat. No. 11,084,734, which claims the benefit of U.S. Application No. 62/667,383 filed on May 4, 2018, which are incorporated by reference herein in their entirety.

### STATEMENT OF GOVERNMENT INTEREST

This invention was made with government support under the award DMR-1553519 from the National Science Foundation. The government has certain rights in this invention.

### TECHNICAL FIELD

This invention relates the synthesis of lithium lanthanum zirconate (LLZO) from lanthanum zirconate (LZO) nanocrystals. The LLZO can be in the form of a layer (e.g., a thin film) or other structure.

### SUMMARY

Lithium lanthanum zirconate (Li₇La₃Zr₂O₁₂, LLZO) is a fast ion conductor for Li-ions suitable for use as a solid electrolyte that can enhance the energy density and safety of Li-ion batteries. Advantages related to reduction in the size of this material to nanometric dimensions include the ability to stabilize the highly conducting cubic phase without the need for extrinsic dopants, enhanced densification and sintering properties, and lower temperature and lower cost preparation methods. Further, beginning with ultrafine crystals may enable fine-tuning of the final grain size of a dense LLZO film, which may in turn enable Hall-Petch strengthening of the final dense ceramic. As described herein, LLZO thin films are fabricated from salts of lithium and lanthanum (and optionally a dopant such as aluminum, gallium, calcium, tantalum, niobium, or molybdenum, or a combination thereof) mixed with lanthanum zirconate nanocrystals. Stoichiometric Li- and La-precursors are mixed with these nanocrystals to yield a slurry suitable for tape casting resulting in thin films, which after calcination and sintering, results in LLZO thin films having fine grain structure and superior mechanical properties (e.g., flexible, non-brittle) suitable for facile incorporation into battery fabrication schemes. In some implementations, lanthanum zirconate nanocrystals containing excess lanthanum and optionally a dopant such as aluminum, gallium, calcium, tantalum, niobium, molybdenum, or a combination thereof is mixed with salts of lithium and then calcined and sintered to form LLZO.

In a first general aspect, fabricating a layer including lithium lanthanum zirconate (Li₇La₃Zr₂O₁₂) includes forming a slurry including lanthanum zirconate (La₂Zr₂O₇) nanocrystals, a lithium-containing compound, and a lanthanum-containing compound to yield a dispersion including lithium, lanthanum, and zirconium. The slurry is dispensed onto a substrate and dried, and the dried slurry is calcined to yield the layer including lithium lanthanum zirconate.

Implementations of the first general aspect may include one or more of the following features.

The lithium-containing compound can include lithium nitrate. The lanthanum-containing compound can include lanthanum nitrate.

In some cases, the slurry includes a dopant, such as one or more of aluminum, gallium, tantalum, niobium, and molybdenum. In some cases, the slurry includes a dispersant, such as one or more of a surfactant, fish oil, poly(acrylic acid) and salts thereof, poly(methacrylic acid) and salts thereof, and phosphate esters. In some cases, the slurry includes a plasticizer, such as one or more of polyethylene glycol, benzyl butyl phthalate, and glycerol. In some cases, the slurry includes a binder, such as polyvinylbutyral.

Disposing the slurry on the substrate can include casting the slurry on the substrate (e.g., tape-casting or spin-casting) or dip-coating the substrate in the slurry. Calcining the dried slurry can include heating the dried slurry at a temperature between 700 °C and 1200 °C for a few minutes to several hours. In some cases, forming the slurry includes forming the slurry in one or more of methanol and ethanol.

The lanthanum zirconate nanocrystals typically have an average diameter in a range of 5 nm to 50 nm, or in a range of 10 nm to 30 nm. The layer including lithium lanthanum zirconate typically has a grain size of less than 300 nm. A thickness of the layer is typically in a range of 1 μm to 500 μm, or 5 μm to 500 μm.

The lithium lanthanum zirconate can be cubic phase lithium lanthanum zirconate. The dispersion can include lithium, lanthanum, and zirconium in a molar ratio of 7:3:2, or in a molar ratio of more than 7 moles lithium to 3 moles lanthanum to 2 moles zirconium (e.g., an excess of lithium).

In a second general aspect, synthesizing lithium lanthanum zirconate (Li₇La₃Zr₂O₁₂) includes combining lanthanum zirconate (La₂Zr₂O₇) nanocrystals having excess lanthanum with one or more salts of lithium to yield a mixture; calcining the mixture to yield a calcined mixture; and sintering the calcined mixture to yield lithium lanthanum zirconate.

Implementations of the second general aspect may include one or more of the following features.

The lanthanum zirconate nanocrystals can include a dopant. The one or more salts of lithium can be molten. The mixture can be in the form of a slurry.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF THE DRAWINGS

FIG. 1 shows a schematic illustrating the formation of Li₇La₃Zr₂O₁₂ (LLZO) thin films from La₂Zr₂O₇ (LZO) nanoparticle slurries.

FIG. 2 shows a representative X-ray diffraction (XRD) pattern of LZO formed from molten salt synthesis (used as a precursor to LLZO).

FIGS. 3A-3D show representative transmission electron microscopy (TEM) images of the LZO used as a precursor.

FIG. 4 shows a representative XRD pattern of LLZO formed after calcination of a tape-cast film at 900 °C for 6 hours.

FIGS. 5A and 5B show representative TEM images of off-stoichiometric nanocrystals with a nominal composition of La_{2.4}Zr_{1.12}Ta_{0.48}O₇ (corresponding to a La:Zr:Ta ratio of 3:1.4:0.6) used as a precursor to make LLZO. FIG. 5C shows XRD patterns of various off-stoichiometric, doped, and co-doped LZO nanocrystals synthesized using molten salt reaction compared to stoichiometric nanocrystals and powder synthesized using solid state reaction (SSR).

FIGS. 6A and 6B show representative XRD patterns of products obtained after using nanocrystals with a nominal composition of La_{2.4}Zr_{1.12}Ta_{0.48}O₇₊ₓ (LZTO), where x=0.04, as precursors to prepare Ta-doped LLZO (LLZTO) with a nominal composition of Li_{6.4}La₃Ta_{0.6}Zr_{1.4}O₁₂ in a molten salt (NaOH:KOH eutectic) containing different amounts of Li₂O₂ at different reaction temperatures and reaction times. FIGS. 6C and 6D are representative scanning electron microscopy (SEM) and high-angle annular dark-field (HAADF) STEM images, respectively, of LLZTO synthesized by molten salt synthesis (MSS) using off-stoichiometric doped LZO as the La, Zr, and Ta source.

FIGS. 7A and 7B show schematics illustrating the formation of LLZTO particles from the reaction of LZTO nanocrystals in a molten salt reaction (NaOH:KOH eutectic) containing Li₂O₂. The LLZTO particles can then be processed into a slurry and fabricated into a thin film using tape-casting.

FIG. 8 shows a schematic illustrating the formation of a LLZTO pellet from LZTO nanocrystals by solid state reaction with a lithium source (e.g., LiOH) after high temperature sintering.

FIG. 9A shows a representative XRD pattern of LLZTO formed from sintering LZTO (nominal composition La_{2.4}Zr_{1.12}Ta_{0.48}O₇) nanocrystals with stoichiometric anhydrous LiOH (i.e., 6.4 moles LiOH to 3 moles La) with 5% excess and sintering at 1200 °C. FIG. 9B shows a representative SEM image of the pellet fracture surface. FIG. 9C shows an enlarged view of an identified region in FIG. 9B.

### DETAILED DESCRIPTION

Lithium lanthanum zirconate (Li₇La₃Zr₂O₁₂, LLZO) can be synthesized using a variety of methods, such as solid-state reaction, sol-gel, chemical or atomic layer deposition, and molten salt synthesis. In most of these synthesis methods, La₂Zr₂O₇ (LZO) is formed as an intermediate phase at lower temperatures, shorter reaction times, or both than required to obtain LLZO. Further reaction of the LZO with Li- and La-precursors lead to the formation of LLZO. Hence, one route towards obtaining nanostructured LLZO is to begin with nanostructured LZO as a starting phase.

Molten salt synthesis (MSS) (sometimes known as “salt melt synthesis” or the “molten salt method”) can be used to obtain various-sized particles of ceramics from generally inexpensive precursors at temperatures or times lower than those required in solid state reactions. In MSS, precursors including or consisting of metal oxides or metal salts are mixed intimately with a salt (or salt mixture, often a eutectic), followed by heat treatment above the melting point of the salt(s) to provide the thermodynamic driving force for dissolution of the precursors and to promote the formation of the desired crystalline phase. Synthesis of LZO in a eutectic mixture of sodium hydroxide and potassium hydroxide (41:59 wt % NaOH:KOH) is also described. In this process, MSS is used to obtain non-agglomerated LZO nanopowders in large quantities suitable as a reagent for formation of LLZO. These more uniform and fine powders may enable roll-to-roll processing of electrolyte materials, e.g., tape-casting, and thus better incorporation into practical battery production methods. This factor can help overcome the challenge of using a brittle, crystalline ceramic as an electrolyte. On a lab scale, tens of grams of uniform LZO can be obtained in a matter of hours using a single small furnace, indicating that this synthesis approach provides a scalable method of LLZO production.

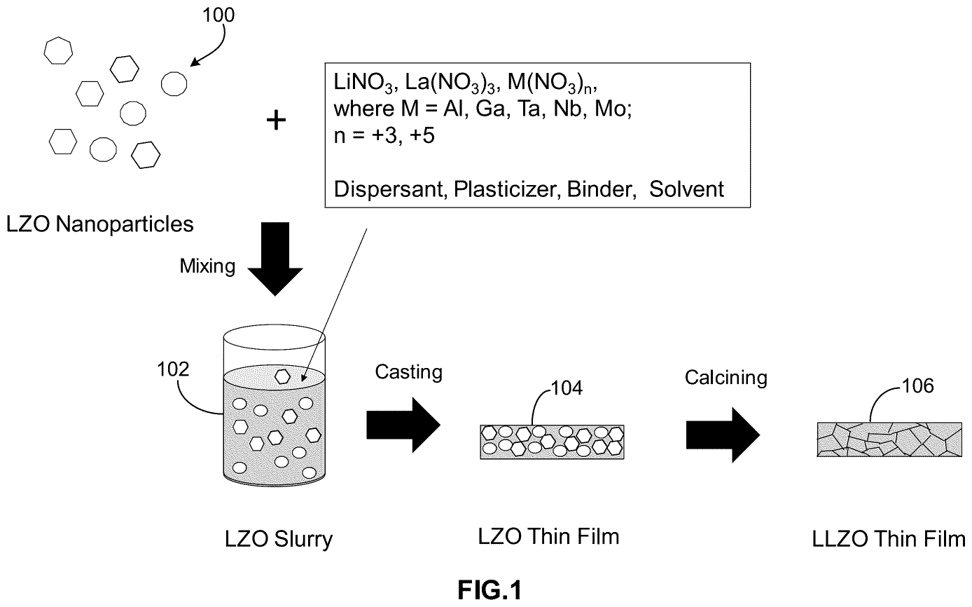

FIG. 1 depicts the formation of LLZO thin films from LZO nanoparticle slurries. LZO nanocrystals 100 with diameters of about 20 nm may be prepared by MSS in a eutectic mixture of NaOH and KOH at elevated temperatures (e.g., 400-550 °C) for 1-4 hours, among other possible methods. LZO nanocrystals 100 can also be synthesized using other methods such as hydrothermal synthesis, sol-gel synthesis, and salt-assisted combustion synthesis. These LZO nanocrystals are dispersed in polar media (e.g., water and low molecular weight alcohols such as methanol or ethanol) or non-aqueous organic solvent systems (such as ethanol and methyl ethyl ketone, or ethanol and toluene), sometimes with the aid of a dispersant, to yield slurry 102 of LZO nanocrystals. In some implementations, slurry 102 includes LiNO₃, La(NO₃)₃, M(NO₃)ₙ, or a combination thereof, where M includes one or more of Al, Ga, Ta, Nb, and Mo, and n=+3 or +5. In some implementations, slurry 102 includes one or more of a dispersant, a plasticizer, and a binder in the solvent.

The LZO nanocrystals can then act as substrates upon which to form LLZO if suitable Li-, La-, and other (e.g., dopant) precursors are added in appropriate (e.g., stoichiometric) quantities to the slurry. Slurry 102 can be cast into LZO layer 104 and dried, followed by calcination to complete the conversion of LZO to LLZO layer 106. In some cases, layers 104 and 106 are thin films. Layers 106 of LLZO can be formed by methods including tape-casting, spin-casting, and dip-coating to convert the nanocrystalline LZO into fine-grained LLZO films by solid phase reaction and subsequent sintering.

In some implementations, LZO nanocrystals that contain excess amount of lanthanum and optionally dopants are prepared such that only suitable amounts of Li precursor is required in order to transform the LZO into LLZO. By including all of the required elements, except for Li, within the nanocrystal, the transformation to LLZO can be achieved in a facile manner in a molten salt reaction or calcination as discussed previously.

### EXAMPLES

### Example 1: Synthesis of La₂Zr₂O₇ (LZO) Nanocrystals and Transformation to Al-Doped LLZO by Tape-Casting

All reagents used were of ACS grade or higher and used as-received. Sodium Hydroxide (NaOH), potassium hydroxide (KOH), lithium nitrate (LiNO₃), zirconium oxynitrate (ZrO(NO₃)₂) hydrate, and aluminum nitrate (Al(NO₃)₃) nonahydrate (used to provide Al³⁺ dopants to stabilize the cubic structure of LLZO) were obtained from Sigma-Aldrich. Lanthanum nitrate (La(NO₃)₃) hexahydrate was obtained from Alfa Aesar. HPLC grade methanol was obtained from BDH, poly(vinylbutyral) was obtained from Alfa-Aesar, and PEG 400 was obtained from Aldrich. Other reagents similar to those described above may also be used.

To prepare the hydroxide mixture, 41 wt % NaOH and 59 wt % KOH were mixed followed by melting above 400-550 °C (melting point of NaOH-KOH eutectic mixture ~170 °C). The LZO nitrate precursors were prepared by mixing La(NO₃)₃, and ZrO(NO₃)₂ in a 1:1 molar ratio and grinding thoroughly with a mortar and pestle.

The premixed nitrate precursor salts were then added carefully to the pre-heated molten hydroxide mixture, which produced an evolution of water vapor and other gases (e.g., NOx). Once the precursors were added to the molten hydroxides, the crucible was briefly mixed by agitation and reintroduced to the furnace for a few minutes to a few hours.

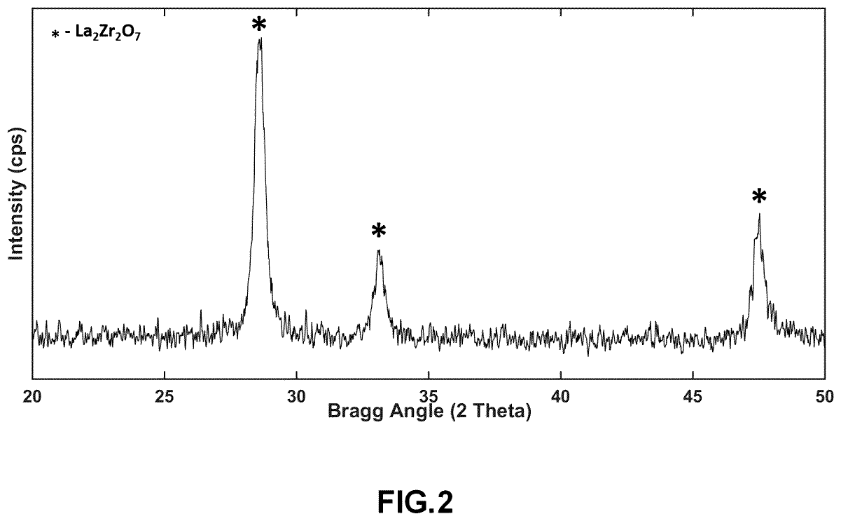

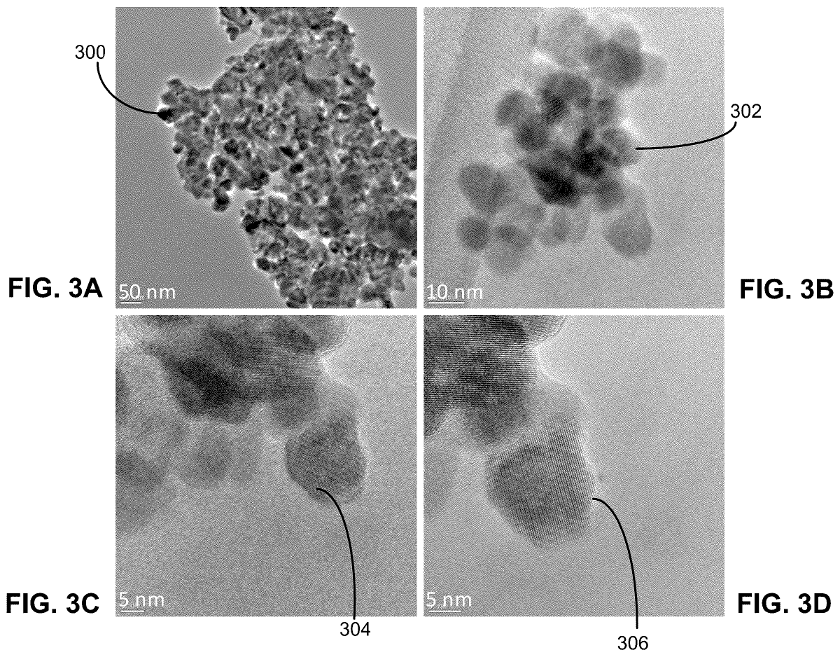

After the synthesis, ultrapure water (>18 MOhm cm) was added to the cooled crucibles, and the suspension was ultrasonicated using an immersion probe (Cole-Parmer 500 W Ultrasonic Processor) to rapidly dissolve the fused hydroxides and generate a slurry of powder. Subsequently, the slurry was vacuum filtered using poly(vinylidene fluoride) membranes (0.22 μm pore size, DuraPore, EMD corporation) and washed with at least 150 mL of water followed by 50 mL of methanol (BDH, HPLC grade) to facilitate fast drying. Conversely, the solution may be washed by repeated centrifugation, decantation of supernatant solution, addition of further ultrapure water and resuspension of powders by ultrasonication. Finally, the filter membranes or centrifuge tubes along with the wet powder cakes were placed in an oven at elevated temperature (e.g., 50 °C) and dried in air. After drying, the powders were removed from the filter membranes or tubes and lightly ground with a mortar and pestle. FIG. 2 shows a representative X-ray diffraction (XRD) pattern of the as-synthesized LZO nanocrystals, and FIGS. 3A-3D show representative transmission electron microscopy (TEM) images of the LZO nanocrystals 300, 302, 304, and 306, respectively.

Formation of a slurry suitable for tape-casting can be performed by mixing nanocrystalline LZO and methanol in a 1:2 ratio (by mass). Subsequently, stoichiometric nitrates of Li, La, and optionally Al (as dopant) may be dissolved in the methanolic slurry following by mixing with e.g. ultrasound or planetary ball milling. A dispersant (e.g., surfactant, fish oil, poly(acrylic acid) and salts thereof, poly(methacrylic acid) and salts thereof, and phosphate esters) may be added at this stage as needed. Subsequently, a binder such as poly(vinylbutyral) may be added comprising a few weight percent of the total slurry. The binder can enable formation of a cohesive film upon drying and removal of the solvent. Optionally, a plasticizer such as poly(ethylene glycol) may be added to increase the flexibility to the resultant film. Once these components are added to the slurry, the slurry is ball-milled using, for example, a planetary ball mill for extended periods of time to result in a stable slurry with a low settling rate. This slurry may be cast using various methods to form thin films which, upon calcination and sintering, result in thin (30-500 μm) LLZO films.

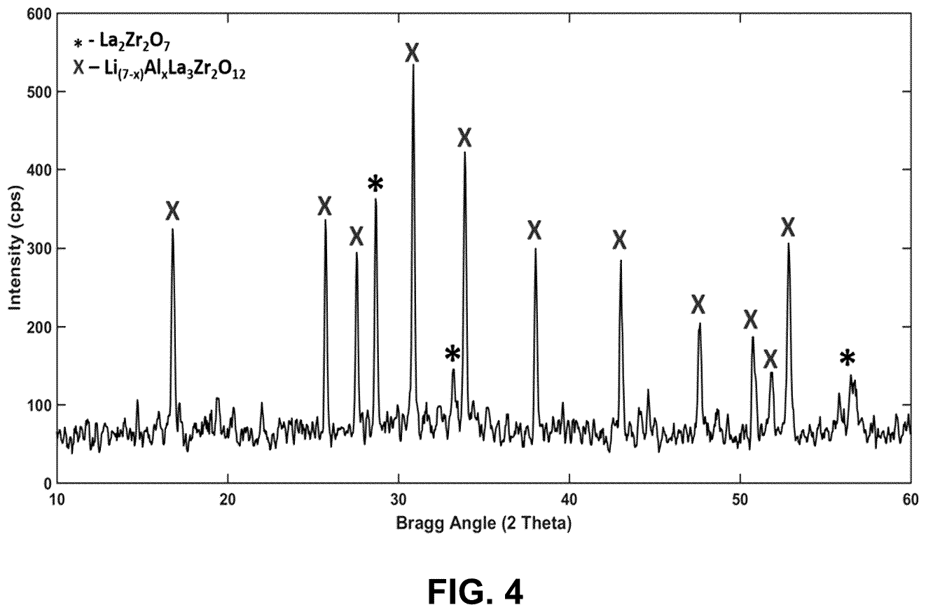

The aforementioned slurry may be tape cast (e.g., using a wire-wound rod coater) in order to form a thin slurry film. Upon drying under the desired conditions (e.g., ambient conditions, elevated temperature, controlled humidity, etc.), a thin, uniform film including nanocrystalline LZO covered in a thin polymer film results. Added Li-, La-, and other precursors are dispersed within this film, adhered to the surface of the LZO crystals, or both. This composite thin film may then be calcined and sintered to yield a film of LLZO. Calcining may include heating at 900 °C for several hours. A representative XRD pattern of a calcined tape showing mostly LLZO (0.3≥x≥0 or 0.25≥x≥0.2) with a small amount of LZO is shown in FIG. 4.

### Example 2: Synthesis of Off-Stoichiometric, Doped LZO Nanocrystals and Transformation to Ta-Doped LLZO

All reagents used were of ACS grade or higher and used as-received. Sodium hydroxide (NaOH), potassium hydroxide (KOH), lithium nitrate (LiNO₃), zirconium oxynitrate (ZrO(NO₃)₂) hydrate, tantalum (V) pentoxide (used to provide Ta⁵⁺ dopants to stabilize the cubic structure of LLZO), sodium fluoride and calcium nitrate tetrahydrate (used to provide Ca²⁺ co-dopants) were obtained from Sigma-Aldrich. Lanthanum nitrate (La(NO₃)₃) hexahydrate was obtained from Alfa-Aesar. Lithium peroxide (Li₂O₂) was obtained from Acros Organics.

The NaOH:KOH eutectic mixture and nitrate salts were prepared in a similar manner as described in Example 1. Typical reaction temperatures were between 400-550 °C with reaction times of 1-4 h. After the synthesis, the products were washed with ultrapure deionized water as described in Example 1.

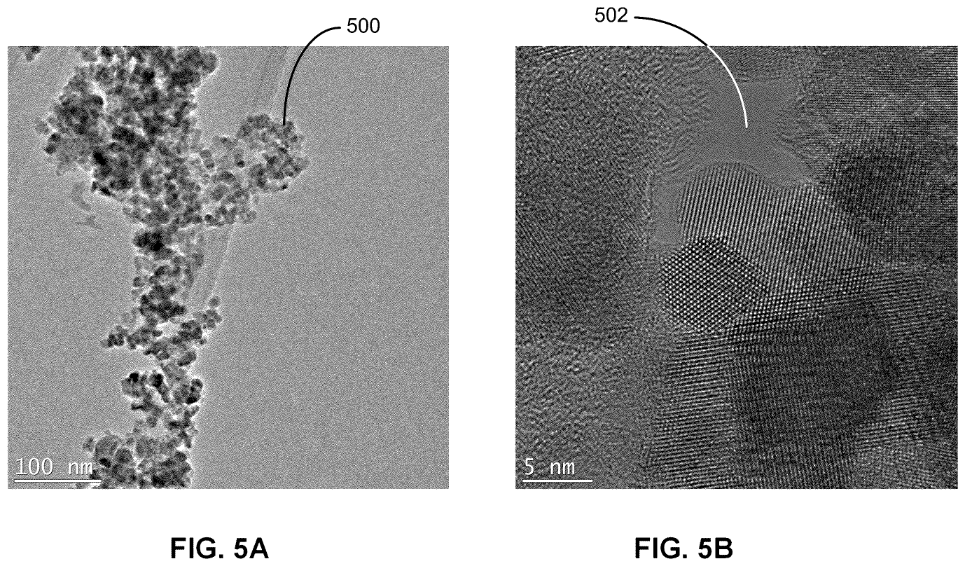

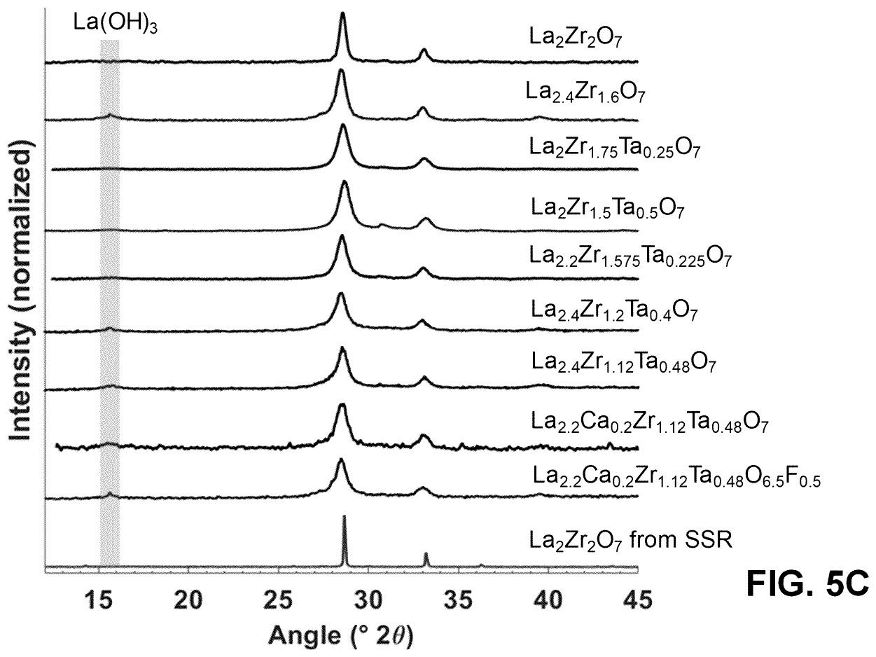

Representative low and high magnification TEM images of the synthesized off-stoichiometric LZO nanocrystals 500, 502 (nominal composition La_{2.4}Zr_{1.12}Ta_{0.48}O₇) are shown in FIGS. 5A and 5B, respectively, showing the nanometric particle sizes. XRD patterns of the LZO nanocrystals with various nominal compositions are shown in FIG. 5C, along with XRD patterns for La₂Zr₂O₇ bulk powder synthesized using solid state reaction (SSR) and stoichiometric La₂Zr₂O₇ nanocrystals synthesized as described in Example 1 for comparison. The peak broadening in the XRD patterns of the nanocrystal samples compared to the SSR sample arises due to the nanometric particle sizes. The XRD results show that it is feasible to synthesize LZO nanocrystals with excess lanthanum, tantalum doping, calcium and tantalum co-doping, and calcium, tantalum and fluorine co-doping while maintaining the same pyrochlore structure using molten salt synthesis. Only small amounts of La(OH)₃ and other unidentified impurity phases were observed in the XRD pattern, suggesting that the dopants were successfully incorporated into the LZO nanocrystals.

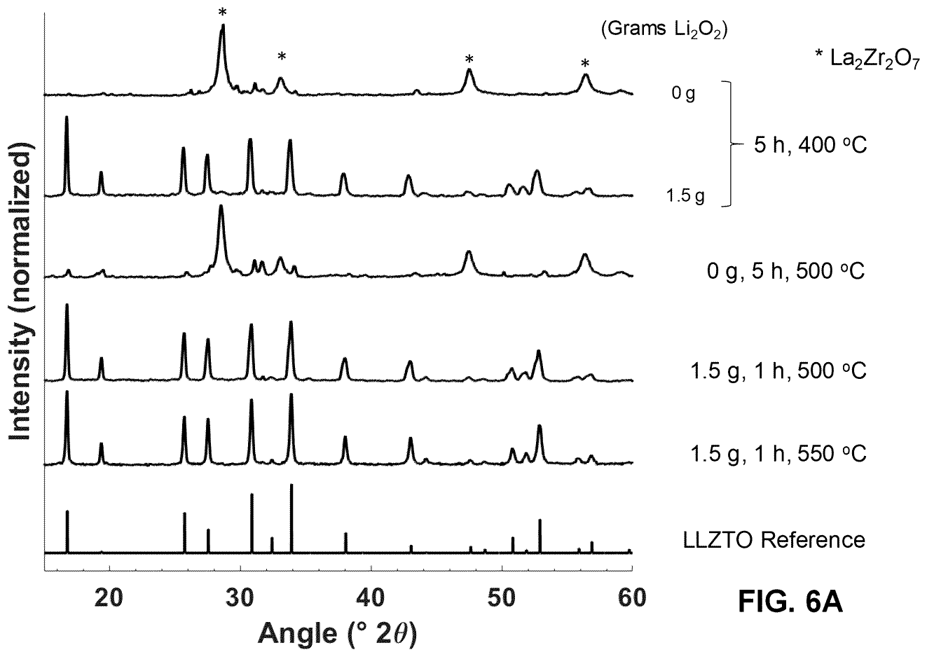

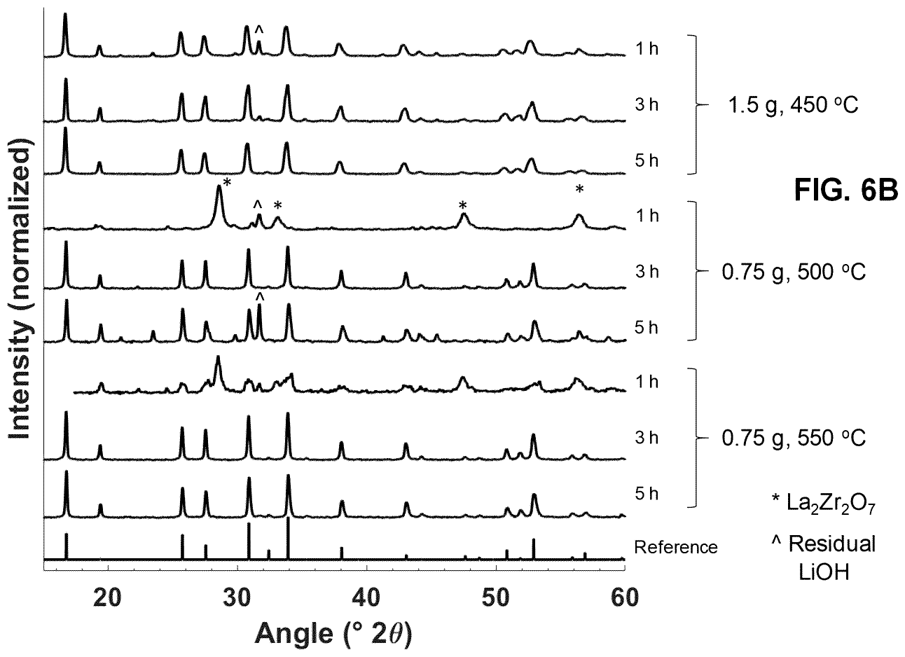

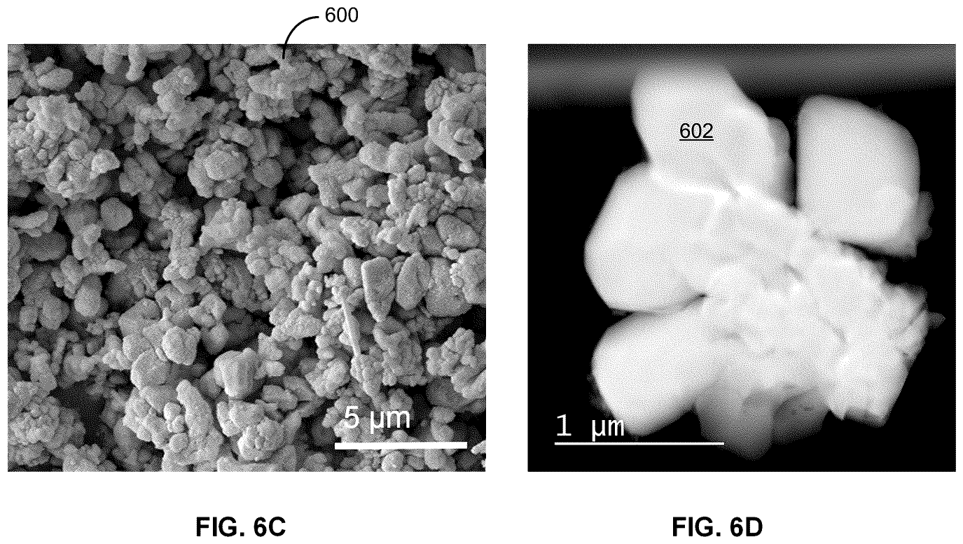

As an example, nanocrystals with nominal composition La_{2.4}Zr_{1.12}Ta_{0.48}O₇₊ₓ (LZTO) where x=0.04 were used as precursors to prepare Ta-doped LLZO (LLZTO) with nominal composition Li_{6.4}La₃Ta_{0.6}Zr_{1.4}O₁₂. The nanocrystals were added to a molten salt flux consisting of 5 g of LiNO₃ and LiOH (1:1 mass ratio) with between 0.75-1.5 g of Li₂O₂ as additive to provide reactive oxygen species. Optionally, the LZTO nanocrystals can be ground together with an equal mass of anhydrous LiNO₃ to dilute them, de-agglomerate them, and help with mixing upon addition to the molten salt flux. Reaction temperature between 400-550 °C were studied, with the reaction time varied from 1-5 h. The products were washed with de-ionized water as described previously. XRD patterns of the formed products are shown in FIGS. 6A and 6B. The results show that the amount of Li₂O₂ added to the salt melt, the reaction temperature, and the reaction time play a role on the transformation of LZTO to LLZTO. As shown in FIG. 6A, when no Li₂O₂ was added, the product remained mostly LZTO after reaction at 400 and 500 °C, Adding 1.5 g of Li₂O₂ was sufficient to form LLZTO after 5 h at 400 °C, and only 1 h at 500 and 550 °C. Other than some residual LiOH from the molten salt, no other crystalline impurity phases were observed. As shown in FIG. 6B, decreasing the amount of Li₂O₂ additive to 0.75 g required a longer reaction time of 3 h to transform the LZTO to LLZTO at 500 and 550 °C. The Li₂O₂ likely plays an important role in providing reactive species for the reaction to proceed. Representative SEM and TEM images of LLZTO particles 600 and 602 formed using LZTO at 550 °C are shown in FIGS. 6C and 6D, respectively, showing that they have submicron diameters. These particles can be used to prepare thin films of LLZTO using tape-casting and other techniques described earlier. These results show that LZTO nanocrystal precursors can be successfully transformed to LLZTO after reaction with Li in a highly basic molten salt flux.

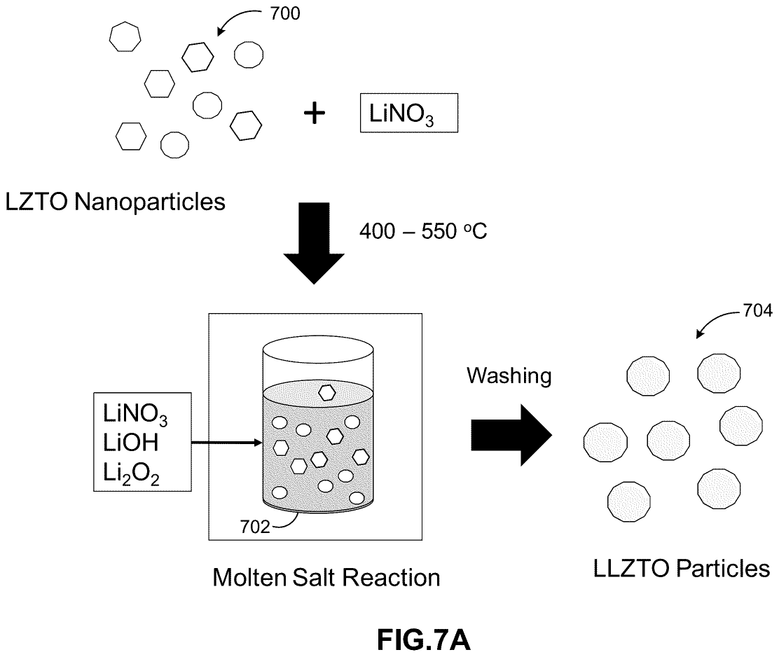

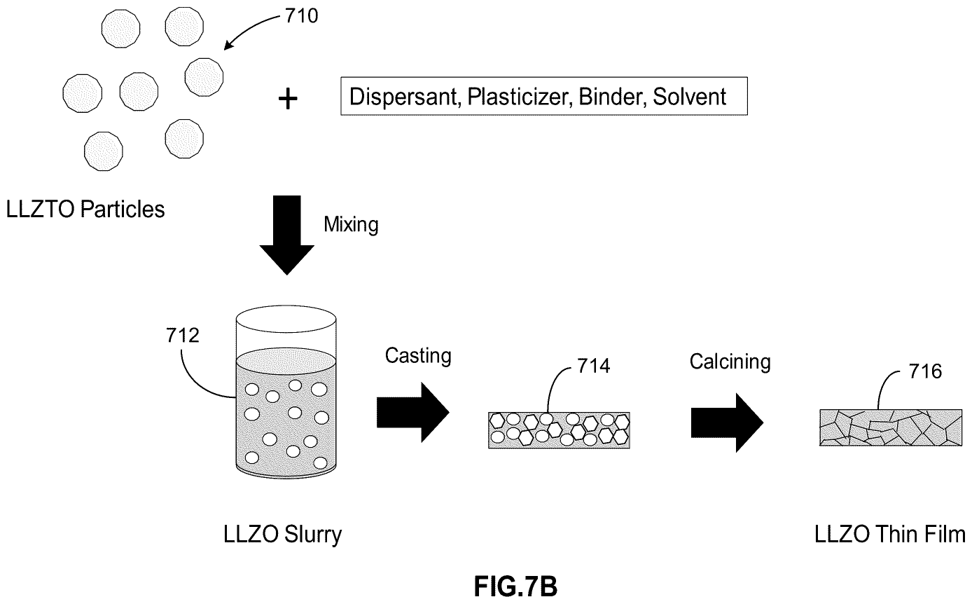

FIGS. 7A and 7B depict the formation of LLZTO powders from LZTO nanoparticles in the molten salt, followed by casting of the LLZTO powders into thin films. As depicted in FIG. 7A, LZTO nanoparticles 700 are added to a molten salt flux 702 including 5 g of LiNO₃ and LiOH (1:1 mass ratio) with between 0.75-1.5 g of Li₂O₂ as an additive to provide reactive oxygen species. Optionally, the LZTO nanocrystals can be ground together with an equal mass of anhydrous LiNO₃ to dilute them, de-agglomerate them, and help with mixing upon addition to the molten salt flux. Reaction temperatures between 400-550 °C and reaction times between 1-5 h can be used. The reaction mixture is washed to yield LLZTO particles 704. As depicted in FIG. 7B, LLZTO nanoparticles 710 are combined with a solvent and one or more of a dispersant, a plasticizer, and a binder to form slurry 712. Slurry 712 is cast to form a layer 714, and layer 714 is calcined to yield LLZO layer 716.

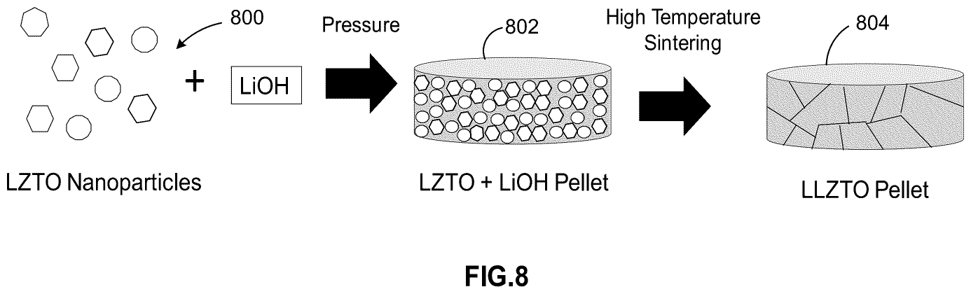

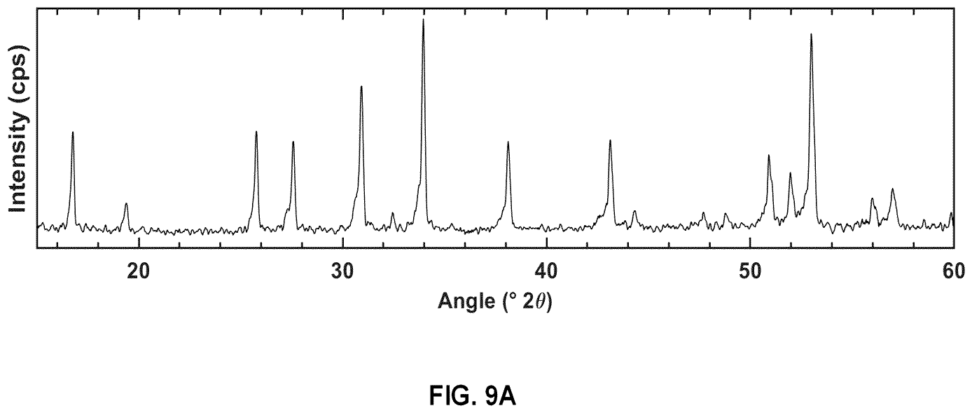

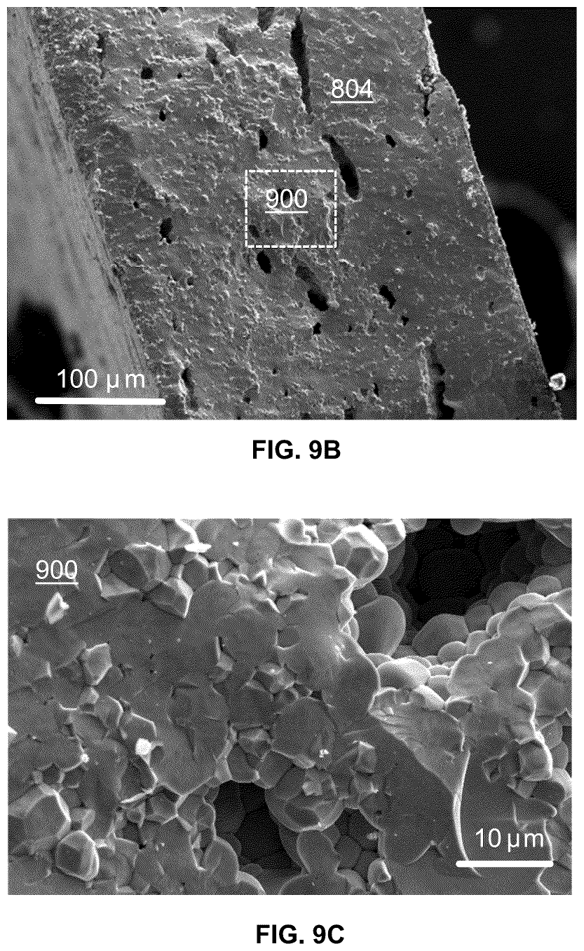

As another example, LZTO (nominal composition La_{2.4}Zr_{1.12}Ta_{0.48}O₇) nanocrystals were transformed to LLZTO by sintering with a lithium source (e.g. LiOH, Li₂CO₃, Li₂O) in the form of pellet. As depicted in FIG. 8, LZTO nanoparticles 800 are mixed with LiOH (e.g., stoichiometric anhydrous LiOH (i.e. 6.4 moles LiOH to 3 moles La) with 5% excess (by mass)) by slurry grinding in a mortar and pestle with water or methanol as the solvent followed by drying, and then pressed into pellets 804 (e.g., 7 mm pellets) and sintered to yield LLZTO pellets 806. Sintering may be achieved using a ramp rate of 4 °C/min to the target temperature. After sintering at 1200 °C for 6 h, pellets with relative density of 79% were obtained. Sintering at 900 °C for 2 h, followed by 1200 °C for 4 h resulted in pellets with slightly higher relative density of 82%. Electrochemical impedance spectroscopy was performed at room temperature after applying graphite contacts to either side of the pellet. The Li ionic conductivity was 0.07 mS/cm for the pellet sintered at 1200 °C for 6 h, while the conductivity increased to 0.23 mS/cm for the pellet sintered with the lower temperature step. FIG. 9A shows an XRD pattern of pellet 804 sintered at 900 °C (2 h) then 1200 °C (4 h). FIG. 9B shows an SEM image of fracture surfaces of pellet 804, and FIG. 9C shows a magnified view of region 900 in FIG. 9B. The XRD pattern showed that the LZTO nanocrystals were successfully transformed to LLZTO without forming any secondary phases. The SEM images show that the pellet has a highly dense microstructure and displayed transgranular fracture; however, some large pores were still present which indicate that the sintering conditions need to be further optimized.

These results show that LZTO nanocrystals can serve as precursors to form LLZTO with good ionic conductivity after reaction with lithium. The transformation was successfully conducted in a lithium-containing molten salt flux at moderate temperatures (400-550 °C) as well as in a solid-state reaction with a lithium source using high temperature sintering (1200 °C). It is expected that this transformation will also be feasible in thin films such as those prepared by tape-casting from a slurry containing LZTO nanocrystals and a lithium source.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

1-27. (canceled)

28. A method of synthesizing a tantalum-doped lithium lanthanum zirconate, the method comprising:
combining nanocrystals comprising a tantalum-doped lanthanum zirconate with LiNO₃, LiOH, and Li₂O₂ to yield a mixture; and
heating the mixture to yield the tantalum-doped lithium lanthanum zirconate,
wherein the tantalum-doped lithium lanthanum zirconate comprises Li_{6.4}La₃Ta_{0.6}Zr_{1.4}O₁₂.

29. The method of claim 28, wherein combining the nanocrystals with LiNO₃, LiOH, and Li₂O₂ comprises combining the nanocrystals with a molten salt flux comprising the LiNO₃, LiOH, and Li₂O₂.

30. The method of claim 29, wherein the LiNO₃ and the LiOH are present in the molten salt flux in a mass ratio of 1:1.

31. The method of claim 29, wherein a ratio of the total mass of the LiNO₃ and the LiOH to a total mass of the Li₂O₂ is about 5:1.

32. The method of claim 28, comprising heating the mixture to a temperature in a range of 400 °C to 550 °C.

33. The method of claim 32, comprising heating the mixture for a length of time between 1 and 5 hours.

34. The method of claim 28, further comprising grinding the nanocrystals with the LiNO₃ to yield a precursor mixture.

35. The method of claim 34, wherein the nanocrystals and the LiNO₃ are present in a mass ratio of about 1:1.

36. The method of claim 28, wherein the Li_{6.4}La₃Ta_{0.6}Zr_{1.4}O₁₂ is in the form of particles.

37. The method of claim 36, wherein the particles have submicron diameters.

38. The method of claim 37, further comprising combining the particles with a solvent and one or more of a dispersant, a plasticizer, and a binder to form a slurry.

39. The method of claim 38, further comprising casting the slurry to form a layer on a substrate.

40. The method of claim 39, further comprising calcining the layer.
